(19) United States
(12) Patent Application Publication
(10) Pub. No.: US 2010/0318526 A1
(43) Pub. Date: Dec. 16, 2010

(54) INFORMATION ANALYSIS DEVICE, SEARCH SYSTEM, INFORMATION ANALYSIS METHOD, AND INFORMATION ANALYSIS PROGRAM

(76) Inventors: Satoshi Nakazawa, Tokyo (JP); Toshio Takeda, Tokyo (JP); Shinichi Ando, Kanagawa (JP)

Correspondence Address: Mr. Jackson Chen, 6535 N. STATE HWY 161, IRVING, TX, 75039, US

(21) Appl. No.: 12/864,780

(22) PCT Filed: Jan. 30, 2009
(86) PCT No.: PCT/JP2009/051581

§ 371 Date: Jul. 27, 2010

(30) Foreign Application Priority Data
Jan. 30, 2008 (JP) 2008-019014

(51) Int. Cl. G06F 17/30

(52) U.S. Cl. 707/749; 707/769; 707/E17.014

(57) ABSTRACT

Time-series data corresponding to an input linguistic expression to be analyzed is acquired, a relevant linguistic expression candidate which is highly relevant to the input linguistic expression is generated, time-series data corresponding to the relevant linguistic expression candidate generated is acquired, temporal correlation between the time-series data corresponding to the input linguistic expression and the time-series data corresponding to the relevant linguistic expression candidate is analyzed and a relevance level between the input linguistic expression and the relevant linguistic expression candidate generated is calculated using an analysis result of the time-series data.

### TECHNICAL FIELD

The present invention relates to an information analysis apparatus, an information analysis method and a program for information analysis for analyzing information. The present invention also relates to a search system which uses the information analysis apparatus.

### BACKGROUND ART

A description that expresses a certain noun, topic, opinion, or thing in text will be referred to as a “linguistic expression.” Examples of the “linguistic expression” include a nominal expression such as an event name, a name of an affair, and a product name (e.g., “racing game,” “earthquake-proof gel,” and “food mislabeling”) and a sentence that contains a nominal expression with a predicate and/or a modifier (e.g., “Earthquake-proof gel is effective” and “Diesel engines are environmentally friendly”), A “linguistic expression” may be an actual character string that shows up in text or a result of analysis performed on the text using an existing natural language processing technique such as morphological analysis, syntactic analysis, dependency analysis, and synonym processing.

For example, linguistic expressions such as “school” and “student” include a single word. Dependency analysis on text including “go to school,” “went to school,” and “hurried to school” generates a word-to-word dependency analysis result such as “go school,” which provides a linguistic expression expressing an organized meaning.

Suppose a large set of documents such as blogs on the Internet, emails, and correspondence history in a call center is given as an analysis population. A text mining technique (hereinafter, referred to as first related art) targets a certain linguistic expression contained in a part of the population of the set of documents, and extracts a linguistic expression which is highly relevant to the target linguistic expression from the set of documents.

For example, NPL 1 describes correlation analysis which bases on a co-occurrence level as a text mining technique for analyzing free text questionnaires. According to the correlation analysis which bases on the co-occurrence level, relevance between words is evaluated to be high, based on such information that the words co-occur in the same document. Using the co-occurrence level, a linguistic expression which is highly relevant to a certain linguistic expression can be extracted by examining the co-occurrence relationship between one linguistic expression and another, not only in units of words but also in units of linguistic expressions including predicates consisting of a plurality of words and dependency relationship between words.

Using the analysis technique based on the co-occurrence level, it can be seen that, for example, questionnaire documents often contain a linguistic expression such as “answer→no,” “contact→no,” or “failure→a lot,” which is highly relevant to a dependency-based linguistic expression of “support→dissatisfactory,” The linguistic expression highly relevant to a target linguistic expression can originate from a cause or effect of the target linguistic expression, another effect of a common cause, or a phenomenon which is simply and highly relevant to a common situation or environment. In any case, the highly relevant linguistic expression provides important findings on the target linguistic expression.

Time information including date and/or time of issuance, creation, and/or correspondence may generally be inherent to the foregoing set of documents such as blogs on the Internet, entails, and correspondence history in the call center. There is a technique which extracts documents containing a target linguistic expression from the large set of documents having the time information, sorts the extracted documents in order of the time information attached thereto, and performs time-series analysis to check the number of times when the target linguistic expression shows up or is discussed about.

For example, NPL 2 describes a technique called BlogWatcher. The technique described in NPL 2 (hereinafter, referred to as second related art) is to plot, on a line chart, time-series changes in the number of occurrences of a certain topic word, the number of positive descriptions of the topic word, and/or the number of negative descriptions of the same in the entire collection of blogs.

By examining the changes in the number of occurrences of a target topic word in the blogs using the second related art, the user can make such an analysis as how prevalent the target topic word was at each point in time. In addition, NPL 2 describes a function of detecting a point where the number of occurrences of the target topic word increased abruptly as a burst. As employed herein, the term burst indicates an abrupt increase/decrease of the target topic word within a given time period. Moreover, NPL 2 describes a technique of normalization with the total population size of the collected blogs in addition to a simple increase/decrease; however, the burst is basically detected in response to a change in the number of occurrences of the target topic word.

### CITATION LIST

### Non-Patent Literature

{NPL 1} Kenji Yamanishi, “Data Text Mining,” [online], [searched on 16 Jan. 2008], the Internet<URL: http://www.nec.co.jp/rd/DTinining/members/yainanishi/comp.pdf>
{NPL 2} Tomoyuki Nanno, Yasuhiro Suzuki, Toshiaki Fujiki, Manabu Okumura, “Automatic Collection and Monitoring of Japanese Weblogs,” Transactions of the Japanese Society for Artificial Intelligence, Vol. 19 (2004), No. 6, pp. 511-520

### SUMMARY OF INVENTION

### Technical Problem

According to the first related art, a set of documents containing the target linguistic expression (hereinafter, referred to as a set of target documents) is selected as an analysis target from the population of a given set of documents. In each piece of text in the set of target documents, a linguistic expression which statistically-frequently co-occurs with the target linguistic expression is extracted as a highly relevant linguistic expression. A linguistic expression which rarely shows up in the set of target documents is therefore not able to be extracted even though the expression is highly relevant to the target linguistic, expression.

In general, a linguistic expression which expresses a cause or effect of an opinion or phenomenon given from the target linguistic expression will not always appear in the documents that contain the original target linguistic expression. Even though the target linguistic expression and a highly relevant linguistic expression co-occur in some of the set of target documents, it is not always possible to expect that the highly relevant linguistic expression statistically-frequently shows up in many of the set of target documents.

For example, given that a linguistic expression “product A is cool” is set as a target linguistic expression and that documents containing the target linguistic expression have recently been on the increase. That is, a phenomenon, which is the opinion “product A is cool” has been increasing, is given. Supposing the phenomenon provides one of the causes of another phenomenon that fashion model Ms. B who is a user of the product A is rising in popularity, the latter phenomenon can be observed as an increase of linguistic expressions such as “Ms. B is nice” and “Ms. B is beautiful.”

Even though the two linguistic expressions co-occur in such a way that “Ms. B is beautiful, and product A which is Ms. B is using is cool” in some documents, it can not be expected that, in many of the set of target documents which include the target linguistic expression “product A is cool”, an essentially-relevant linguistic expression of “Ms. B is nice” or “Ms. B is beautiful” shows up in co-occurrence. According to the first related art, which provides the technique to extract highly relevant linguistic expressions based on co-occurrence in the same documents, it is therefore difficult to appropriately extract a linguistic, expression relevant to the target linguistic expression.

Regression analysis is an example of basic techniques of the statistical analysis. When a certain phenomenon gives sets of time-series data such as the numbers of occurrences or prices at respective time points, the regression analysis technique is used to examine time variations in the sets of time-series data for correlation and to detect a highly relevant phenomenon. For example, when time variation of a stock price is correlated with time variation of another stock price, the prices of the two stocks at respective time points are regarded as sets of time-series data for the regression analysis. As a result, strength of the correlation between the two prices can be calculated.

Even though a target phenomenon is expressed by certain linguistic expressions without direct time-series data such as the stock price, if a set of documents to be the analysis population is given with time information, the second related art can be used to determine the time-series data of each linguistic expression. In such a case, the set of documents or the analysis population is divided into time periods based on the time information, and the numbers of documents containing the linguistic expressions or the numbers of occurrences of the linguistic expressions in each period provides the time-series data of the linguistic expressions in each period.

Consequently, by determining correlation between the sets of time-series data on the given linguistic expressions using a statistical technique such as the regression analysis, detecting a linguistic expression as the relevant linguistic expression is possible when the expressions are temporally-highly correlated with each other even though the expressions do not always co-occur in the same documents.

With the use of the statistical technique such as the regression analysis, and with a set of documents to be analyzed given as the population, each document in the set of documents can contain an enormous number of linguistic expressions. Therefore, to determine a linguistic expression which is temporally-highly correlated with a certain target linguistic expression, it is required to calculate temporal correlation between the enormous expressions. Such a technique of determining the temporal correlation in the time-series data on linguistic expressions is unrealistic in view of computational complexity, when the population of the set of documents to be analyzed such as the Internet or a large amount of correspondence history is enormous in scale.

It is thus an exemplary object of the present invention to provide an information analysis apparatus, a search system, an information analysis method, and a program for information analysis which can analyze relevance between a target linguistic expression and a linguistic expression statistically less likely to co-occur with the target linguistic expression in the same documents.

### Solution to Problem

An exemplary information analysis system according to the present invention includes:

a target linguistic expression time-series data acquisition unit configured to acquire time-series data corresponding to an input linguistic expression to be analyzed;
a relevant linguistic expression candidate generation unit configured to generate a relevant linguistic expression candidate which is highly relevant to the input linguistic expression;
a relevant linguistic expression candidate time-series data acquisition unit configured to acquire time-series data corresponding to the relevant linguistic expression candidate generated by the relevant linguistic expression candidate generation unit;
a time-series analysis unit configured to analyze temporal correlation between the time-series data acquired by the target linguistic expression time-series data acquisition unit and the time-series data acquired by the relevant linguistic expression candidate time-series data acquisition unit; and
a relevance level calculation unit configured to calculate a relevance level between the input linguistic expression and the relevant linguistic, expression candidate generated by the relevant linguistic expression candidate generation unit using an analysis result of the time-series analysis unit.

An exemplary search system according to the present invention includes: the information analysis apparatus;

a relevant information containing document search unit configured to search, making the relevant linguistic expression output from the information analysis apparatus as a search condition, a plurality of search target documents for a document containing the relevant linguistic expression and having a high relevance level, to a target linguistic expression; and
a relevant document output unit configured to output the document searched by
the relevant information containing document search unit.

An exemplary information analysis method according to the present invention includes:

acquiring time-series data corresponding to an input linguistic expression to be analyzed;
generating relevant linguistic expression candidate which is highly relevant to the input linguistic expression;
acquiring time-series data corresponding to the relevant linguistic expression candidate generated;
analyzing temporal correlation between the time-series data corresponding to the input linguistic expression and the time-series data corresponding to the relevant linguistic expression candidate; and
calculating a relevance level between the linguistic expression and the relevant linguistic expression candidate generated, using a result of analyzing the temporal correlation between the time-series data.

An exemplary program for information analysis according to the present invention causing a computer to perform:

acquiring time-series data corresponding to an input, linguistic expression to be analyzed;
generating relevant linguistic expression candidate which is highly relevant to the input linguistic expression;
acquiring time-series data corresponding to the relevant linguistic expression candidate generated;
analyzing temporal correlation between the time-series data corresponding to the input linguistic expression and the time-series data corresponding to the relevant linguistic expression candidate; and
calculating a relevance level between the linguistic expression and the relevant linguistic expression candidate generated, using a result of analyzing the temporal correlation between the time-series data.

### ADVANTAGEOUS EFFECTS OF INVENTION

According, to the present invention, it is possible to analyze relevance between a target linguistic expression to be analyzed and a linguistic expression statistically less likely to co-occur with the target linguistic expression in the same documents.

### BRIEF DESCRIPTION OF DRAWINGS

FIG. 1 is a block diagram showing a configuration of an information analysis apparatus according to the first embodiment of the present invention

FIG. 2 is a block diagram showing an example of a detailed configuration of a relevant linguistic expression candidate generation unit (shown in FIG. 1).

FIG. 3 is an explanatory diagram showing an example of time-series data on relevant linguistic expression candidates that are positively correlated with a target linguistic expression.

FIG. 4 is an explanatory diagram showing an example of time-series data on a relevant linguistic expression candidate which is negatively correlated with a target linguistic expression.

FIG. 5 is a flowchart showing overall processing of relevant information output operation for the information analysis apparatus to perform.

FIG. 6 is a flowchart showing an example of relevant linguistic expression candidate generation processing for the relevant linguistic expression candidate generation unit to perform.

FIG. 7 is a block diagram showing an example of a configuration of the relevant linguistic expression candidate generation unit of the information analysis apparatus according, to the second embodiment of the present embodiment.

FIG. 8 is a flowchart showing an example of the relevant linguistic expression candidate generation processing for the relevant linguistic expression candidate generation unit of the information analysis apparatus according to the second embodiment of the present invention to perform.

FIG. 9 is a block diagram showing an example of a configuration of the relevant linguistic expression candidate generation unit according to the third embodiment of the present invention.

FIG. 10 is a flowchart showing an example of the relevant linguistic expression candidate generation processing for the relevant linguistic expression candidate generation unit according to the third embodiment of the present invention to perform.

FIG. 11 is a block diagram showing an example of a configuration of the relevant linguistic expression candidate generation unit according to the fourth embodiment of the present invention.

FIG. 12 is a flowchart showing an example of the relevant linguistic expression candidate generation processing for the relevant linguistic expression candidate generation unit according to the fourth embodiment of the present invention to perform.

FIG. 13 is a block diagram showing an example of a configuration of a computer for a fault cause analysis system according to the present embodiment.

FIG. 14 is a block diagram showing a configuration of a search system according to the present invention.

### DESCRIPTION OF EMBODIMENTS

### Embodiment 1

Hereinafter, an exemplary first embodiment of the present invention will be described with reference to the drawings. The present invention relates to an information analysis apparatus which uses an information analysis method for extracting, from a set of documents, a relevant linguistic expression which is highly correlated in time series with a target linguistic expression to be analyzed.

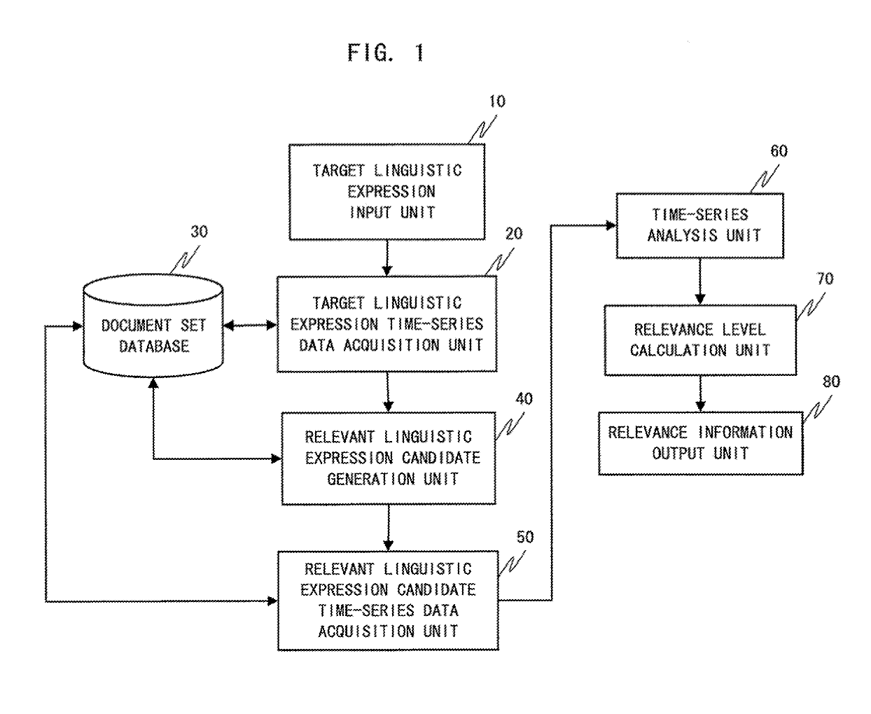

FIG. 1 is a block diagram showing a configuration of the information analysis apparatus according to the first embodiment of the present invention. As shown in FIG. 1, the information analysis apparatus includes a target linguistic expression time-series data acquisition unit 20, a relevant linguistic expression candidate generation unit 40, a relevant linguistic expression candidate time-series data acquisition unit 50, a time-series analysis unit 60, and an relevance level calculation unit 70. A document set database 30 provides a means for accessing a set of documents that is defined as the population of documents to be analyzed. A target linguistic expression input unit 10 enters a linguistic expression to be analyzed into the target linguistic expression time-series data acquisition unit 20. A relevant information output apparatus 80 outputs relevant information that is relevant to the linguistic expression to be analyzed. The information analysis apparatus may include some or all of the target linguistic expression input unit 10, the relevant information output apparatus 80, and the document set database 30. In addition, the information analysis apparatus is implemented by a program-driven information processing apparatus such as a personal computer.

In the present embodiment, the information analysis apparatus is applicable to a search system application which presents, as relevant information or a relevant search condition, a linguistic, expression highly relevant to the linguistic expression entered with the information analysis apparatus.

In the information analysis apparatus shown in FIG. 1, the target linguistic expression input unit 10 inputs a linguistic, expression to be analyzed. The target linguistic expression time-series data acquisition unit 20 acquires time-series data on the target linguistic expression input with the target linguistic expression input unit 10. The document set database 30 provides means for accessing the set of documents that is defined as the population of documents to be analyzed. The relevant, linguistic expression candidate generation unit 40 generates a candidate linguistic expression which is highly relevant to the input target linguistic expression as a relevant linguistic expression candidate. The relevant linguistic expression candidate time-series data acquisition unit 50 acquires time-series data for each relevant linguistic expression candidate, which has been generated.

The time-series analysis unit 60 examines the time-series data acquired by the target linguistic expression time-series data acquisition unit 20 and the time-series data acquired by the relevant linguistic expression candidate time-series data acquisition unit 50 for time-correlation therebetween. Using an analysis result of the time-series analysis unit 60, the relevance level calculation unit 7 calculates a relevance level between the target linguistic expression and the relevant linguistic expression candidate. The relevant information output apparatus 80 outputs a linguistic expression having a high relevance level to the target linguistic expression based on results given by the relevance level calculation unit 70

Specifically, the target linguistic expression input unit 10 is implemented by a CPU of a information processing apparatus, which is driven in accordance with a program, and an input device such as a keyboard and a mouse. The target linguistic expression input unit 10 provides a function to input a linguistic expression to be analyzed in accordance with a user operation.

The target linguistic expression input unit 10 may input the target linguistic expression in a form that specifies a part of text in a document. Any inputting form including the text-input from a keyboard may be used as long, as the linguistic expression is identifiable. The target linguistic expression input unit 10 may input a target linguistic expression in a text form such as “Product A is cool.” The target linguistic expression input unit 10 may enter the target linguistic expression in a data form such as “product A cool,” which is obtained as a result of existing linguistic processing including morphological analysis, syntactic analysis, dependency analysis, and synonym processing.

The target linguistic expression time-series data acquisition unit 20, in particular, is implemented by a CPU of an information processing apparatus which is driven in accordance with a program. The target linguistic expression time-series data acquisition unit 20 realizes a function to acquire time-series data on the target linguistic expression input by the target linguistic, expression input unit 10 from the document set database 30 (extracting the time-series data from the document set database 30).

More specifically, the target linguistic expression time-series data acquisition unit 20 divides the set of documents accessible via the document set database 30 into time periods based on time information attached to each document. The target linguistic expression time-series data acquisition unit 20 also determines the number of documents which contain the target linguistic expression for each period, or the number of occurrences of the target linguistic expression in each period, as the time-series data on the target linguistic expression for each period.

For example, the target linguistic expression time-series data acquisition unit 20 determines the number of occurrences of documents which contain the target linguistic expression for every week, in such a way that 52 documents have been generated in the first week of January, 48 documents in the second week of January, 192 documents in the third week of January, 218 documents in the fourth week of January, . . . and so on. The target linguistic expression time-series data acquisition unit 20 then determines a series of the number of occurrences as the time-series data on the target linguistic expression.

Note that an example of the foregoing method for acquiring the time-series data is described, for example, in NPL 2.

The target linguistic expression time-series data acquisition unit 20 may determine the number of documents which contain the target linguistic expression or the number of occurrences of the target linguistic expression using the actual number, or alternatively, the target linguistic expression time-series data acquisition unit 20 may use, for the determination, a number which is normalized with the total number of documents included in the population to be analyzed in each period or the like.

A range of the time-series data (e.g., start time and end time) and duration of the period (e.g., every hour, day, or week) are appropriately predetermined depending on an application and purpose of implementation of the information analysis apparatus and properties of the analysis population.

When counting the number of documents that contain the target linguistic expression or the number of occurrences of the target linguistic expression in each period in the document set database 30, identification processing on synonymous expressions may be performed, if needed, using existing linguistic processing techniques, e.g., synonym processing, or a identifying analysis result of different expressions or syntaxes, which can be regarded as synonymous with each other. What words or expressions to be considered synonymous in particular is appropriately predetermined depending on the application and purpose of implementation of the information analysis apparatus and the properties of the population to be analyzed.

Specifically, the document set database 30 is implemented by a database unit such as a magnetic disk drive and an optical disc drive, or a network device. The document set database 30 includes a database which stores various types of electronic documents with time information and provides access to a set of documents that is defined as the population of documents to be analyzed. An example of the document set database 30 includes a database unit installed in a call center.

The time information attached to the electronic documents may be any time information including time of creation, issuance, and last update of each document. What type of time information the target linguistic expression time-series data acquisition unit 20 uses as the time information for the time-series data is determined in advance (for example, one type of time information is selected in advance).

The document data of the analysis population need not always be retained inside the information analysis apparatus. If access to the documents is provided, the actual document data may be retained either inside or outside the information analysis apparatus.

For example, the document set database 30 need not be a database unit and may be a blog search engine that searches blogs on the Internet for a particular keyword or date and time. In such a case, the population to be analyzed may be the blog data for the blog search engine to search. The text may be the main body of each blog entry, and the time information may be the date attached to each blog entry.

The relevant linguistic expression candidate generation unit 40, in particular, is implemented by a CPU of an information processing apparatus which is driven in accordance with a program. The relevant linguistic expression candidate generation unit 40 includes a function to generate, as a relevant linguistic expression candidate, a candidate of the linguistic expression which is highly relevant to the target linguistic expression entered with the target linguistic expression input unit 10. The relevant linguistic expression candidate generation unit 40 generates the relevant linguistic, expression candidate using content of the text of the input target linguistic expression, content of the text of the documents that contain the target linguistic expression, or meta information attached to the documents that contain the target linguistic expression.

In the present embodiment, a linguistic expression which does not always co-occur statistically-frequently with the target linguistic expression in the set of target documents can be determined as the relevant linguistic expression. For that purpose, in any case, the relevant linguistic expression candidate generation unit 40 once generates a linguistic expression which has a certain relationship to the target linguistic expression or the set of target documents, as a candidate linguistic expression which is highly relevant to the target linguistic, expression.

When the analysis of the time-series analysis unit 60 subjects even a linguistic expression having no particular relationship to the target linguistic expression to the analysis, it may be possible to detect all linguistic expressions which are temporally highly correlated with the target linguistic expression. However, such a technique is unrealistic because a large computation load is required. Thus, the relevant linguistic expression candidate generation unit 40 narrows down the candidate linguistic expressions to be analyzed with help of the time-series analysis unit 60.

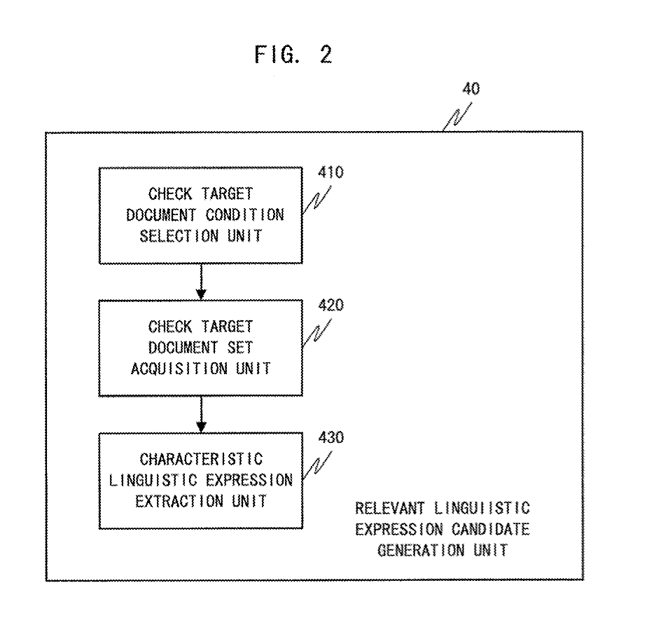

FIG. 2 is a block diagram showing an example of a detailed configuration of the relevant linguistic expression candidate generation unit 40. As shown in FIG. 2, the relevant linguistic expression candidate generation unit 40 includes a check target document condition selection unit 410, a check target document set acquisition unit 420, and a characteristic linguistic expression extraction unit 430.

In the relevant linguistic expression candidate generation unit 40 shown in FIG. 2 the check target document condition selection unit 410 selects a document condition to be checked. The check target document set acquisition unit 420 acquires a set of documents which satisfy the selected condition. The characteristic linguistic expression extraction unit 430 extracts a characteristic linguistic expression from the set of documents acquired.

The check target document condition selection unit 410 includes a function of selecting, a condition of a set of documents, which is a different set of documents from the set of target documents containing the target linguistic expression and has a certain relationship to the target linguistic expression or the set of target documents, to determine a relevant linguistic expression candidate. In the present embodiment, the check target document condition selection unit 410 selects a extraction condition of a comparison target document, using text contents of a electronic document containing the input linguistic expression or meta information attached to the document containing the linguistic expression. In the present embodiment, a document having the certain relationship to the target linguistic expression or the set of target documents is referred to as a check target document. In addition, a set of check target documents is referred to as a set of check target documents.

Table 1 provides a table which shows examples of a check target document condition and examples of a condition of the relevant linguistic expression candidate. As shown in Table 1, examples of the condition which defines the check target document include conditions described in the first row and the first column, the second row and the first column, the third row and the first column, and the fourth row and the first column of Table 1. Examples of the condition of the relevant linguistic expression candidate include conditions described in the first to fourth rows in the second column, the fifth row and the second column, the sixth row and the second column, and the seventh row and the second column in Table 1.

TABLE 1

| | | Condition of relevant linguistic |
|---|---|---|
| Row | Condition of check target document | expression candidate |
| 1 | Set of documents in the same field | Linguistic expression which is |
| | or related to the same | characteristic in check target |
| | topic as the set of target | document described to the |
| | documents | left. |
| | | Characteristic linguistic expression |
| | | indicates any of the following: |
| | | Linguistic expression which shows up |
| | | at high frequency |
| | | Linguistic expression which shows up at |
| | | a significantly high frequency |
| | | in the check target document |
| | | as compared with the |
| | | population of the set of |
| | | documents |
| | | Linguistic expressions which expresses |
| | | the main subject of the check |
| | | target document |
| 2 | Set of documents to which the set | Linguistic expression which is |
| | of target documents is | characteristic in check target |
| | linked within a given | document described to the |
| | number of hops | left. |
| | | Characteristic linguistic expression |
| | | indicates the same linguistic |
| | | expression as the first row. |
| 3 | Set of documents that have given | Linguistic expression which is |
| | similarity to (or are | characteristic in check target |
| | similar to) a document | document described to the |
| | belonging to the set of | left. |
| | target documents as a | Characteristic linguistic expression |
| | result of text similarity | indicates the same linguistic |
| | calculation documents | expression as the first row. |
| 4 | Set of other documents which are | Linguistic expression which is |
| | created or issued by the | characteristic in check target |
| | creator or issuer of the | document described to the |
| | set of target documents | left. |
| | | Characteristic linguistic expression |
| | | indicates the same linguistic |
| | | expression as the first row. |
| 5 | | Linguistic expression which shows up, in |
| | | the set of target documents, |
| | | having a given value of |
| | | correlation or higher in |
| | | correlation with the target |
| | | linguistic expression. |
| 6 | | Linguistic expression description |
| | | relevance to the target |
| | | linguistic expression of which |
| | | is suggested as text in some of |
| | | documents in the set of target |
| | | documents. |
| 7 | | Negative expression of target linguistic |
| | | expression, or linguistic |
| | | expression semantically |
| | | contradictory to target |
| | | linguistic expression. |

The condition shown in the first row and the first column in Table 1 indicates selecting “a set of documents in the same field or related to the same topic as the set of target documents.” The condition shown in the first row and the first column in Table 1 represents a manner of setting such a condition that a document is set as the check target document when the document relates to the same field or relates to the same topic as the set of target documents. That is, in such a case, the check target document condition selection unit 410 selects, as an extraction condition of the comparison target document, whether an electronic document is in the same or similar field or relates to the same or similar topic as all or part of a set of electronic documents containing the input linguistic expression.

To determine the field and topic of the set of target documents, existing text-based field evaluation techniques or topic evaluation techniques can be utilized. When meta information including a field, topic, and the like is attached to each document in the set of target documents, the meta information, may be used.

When documents belonging to the set of target documents relate to a plurality of fields and topics, all the fields and topics may be used as field and topic conditions. Fields and topics, to which a given number of documents or more belonging to the set of target documents relate, may exclusively be used as the conditions.

An evaluation method for a field or a topic, a condition to identify systems, fields, and topics, and the like are set in advance based on the application and purpose of implementation of the information analysis apparatus and the properties of the population to be analyzed. For example, in the case where the population to be analyzed includes blogs on the Internet and the target linguistic expression includes “I bought a DVD recorder,” when a category of “AV equipment” has the largest proportion among meta information of “categories” attached to the documents belonging to the set of target documents, whether a document belongs to the “AV equipment” category can be set as the condition of the check target document.

The condition shown in the second row and the first column in Table 1 indicates selecting “a set of documents to which the set of target documents is linked within a given number of hops.” The condition shown in the second row and the first column in Table 1 represents a manner of setting such a condition that a document is set as the check target document when the document is linked to a document belonging to the set of target documents within a given number of hops. That is, in such a case, the check target document condition selection unit 410 selects, as an extraction condition for the comparison target document, whether an electronic document is linked to the electronic document containing the entered linguistic expression within a certain number of hops.

The above-described mariner is utilized under the assumption that link information to another relevant document is attached as meta information to all or part of the documents belonging to the population to be analyzed. Examples of the linkage include a hyperlink and trackback in the Web text, a source mail H) in a reply email, and a source article of an electronic bulletin board.

The condition shown in the third row and the first column in Table 1 indicates selecting “a set of documents that have given similarity to (or are similar to) a document belonging to the set of target documents as a result of text similarity calculation.” The condition shown in the third row and the first column in Table 1 represents a manner of setting such a condition that a document is set as the cheek target document when the document has a given similarity or more to (or is similar to a document belonging to the set of target documents as a result of the text similarity calculation against a document belonging to the set of target documents. That is, in such a case, the check target document condition selection unit 410 selects, as an extraction condition of the comparison target document, whether an electronic document has text similarity of a given value or lower to an electronic document containing the entered linguistic expression.

Since various methods to calculate inter-text similarity are disclosed as existing linguistic processing techniques, a method of similarity calculation may previously set depending on the application and purpose of implementation of the information analysis apparatus and the properties of the population to be analyzed.

The set of target documents typically includes a plurality of documents. Therefore, whether the check target document has similarity of a certain value or higher to at least any one of the documents or to a center of a cluster assuming the set of target documents as a single document cluster can be set freely.

The condition shown in the fourth row and the first column in Table 1 indicates selecting “a set of other documents which are created or issued by the creator or issuer of the set of target documents.” The condition shown in the fourth row and the first column in Table 1 represent a manner of setting such a condition that a document is set as the check target document when the document is created or issued by the creator or issuer of another document belonging to the set of target documents. That is, in such a case, the check target document condition selection unit 410 selects, as an extraction condition of the comparison target document, whether an electronic documents is created or issued by the common creator or issuer of all or part of a set of electronic documents containing the input linguistic expression and is different from the all or part of the set of electronic documents. This manner is utilized under the assumption that meta information showing the document creator or issuer is attached to all or part of the documents belonging to the population to be analyzed.

The set of target documents typically includes a plurality of documents. Therefore, whether the check target document is common in the creator or issuer to at least any one of the documents or a document created or issued by the creator or issuer who has created or issued a given number of documents or more belonging to the set, of target documents (only limited creator or issuer) is set as the check target document can be set freely.

It should be noted that the conditions shown in the first to fourth rows of Table 1 are described as example conditions for defining the documents to be checked, and the conditions for defining the documents to be checked are not limited thereto. For example, a time-based condition such as “a document which is created/issued within a certain period from date and time of creation/issuance of the target document” may be used.

A composite condition may be defined based on and/or combinations of a plurality of conditions. For example, a composite condition such as “a document, to which any of documents in the set of target documents is linked within one hop, or to which any of documents in the set of target documents is linked within two hops and is in the same field as the link origination” may be defined.

The conditions shown in the first to fourth rows in Table 1 for defining the documents to be checked are determined in advance based on the purpose and application of implementation of the information analysis apparatus, the properties of the population to be analyzed and so on. Here, the check target document condition selection unit 410 reads the target linguistic expression and the set of target documents, and puts the predetermined condition(s) into practice. For example, in the case where a condition of “a document belonging to a category to which a maximum number of target documents belong among the category information of documents in the set of target documents” is given, when the largest category is “AV equipment” as a result of reading the set of target documents, the check target document condition selection unit 410 puts the first condition into practice and sets a condition of “a document belonging to the category ‘AV equipment’” to define the check target document.

The check target document set acquisition unit 420 includes a function of acquiring (extracting), from the document set database 30, a set of documents which satisfy the condition determined by the check target document condition selection unit 410.

The characteristic linguistic expression extraction unit 430 includes a function of firstly performing linguistic analysis on the check target documents which are acquired by the check target document set acquisition unit 420. The characteristic linguistic expression extraction unit 430 includes a function of then extracting a characteristic linguistic expression from among linguistic expressions included in the check target document based on the linguistic analysis result. The characteristic linguistic expression extraction unit 430 also includes a function of determining an extracted characteristic linguistic expression as a relevant linguistic expression candidate.

As a technique to extract a characteristic linguistic expression from a document (or a set of documents), various existing, techniques including a text mining technique and document summarizing technique are disclosed. When implementing the information analysis apparatus, an appropriate existing technique ma be selected in advance in view of the application and purpose of the information analysis apparatus, the properties of the population to be analyzed and so on.

The first to fourth rows and the second column in Table 1 show examples of methods for extracting a characteristic linguistic expression from the check target document of a relevant linguistic expression candidate. The condition of a relevant linguistic expression candidate described in the first row and the second column of Table 1 is “a linguistic expression which is characteristic in a check target document described to the left” Examples of the characteristic linguistic expression include “a linguistic expression which shows up at high frequency,” “a linguistic expression which shows up at a significantly high frequency in the check target document as compared with the population of the set of documents,” and “a linguistic expressions which expresses the main subject of the check target document.” A linguistic expression other than the above-described linguistic expressions may be extracted as a characteristic linguistic expression. A threshold value used for evaluation on “a linguistic expression which shows up at high frequency” or the like is set in advance.

The conditions of the relevant linguistic expression candidate in the second to fourth rows and the second column of Table 1 are the same as the condition of the relevant linguistic expression candidate in the first row and first column, except that a condition of the check target document is different. In Table 1, the characteristic linguistic expression in the second to fourth rows and the second column is the same as the first row and the first column; however, the characteristic linguistic expression in each row may be arbitrarily selected from among “a linguistic expression which shows up at high frequency,” “a linguistic expression which shows up at a significantly high frequency in the check target document as compared with the population of the set of documents,” and “a linguistic expression which expresses the main subject of the check target document.”

A condition of the relevant linguistic expression candidate in the fifth row and the second column of Table 1 includes “a linguistic expression which shows up, in the set of target documents, having a given value of correlation or higher in correlation with the target linguistic expression.” As another condition of the relevant linguistic expression candidate, “a linguistic, expression which shows up having a given value of correlation or larger in correlation with the target linguistic expression in a subset of the documents obtained by dividing the set of target documents based on time information or category information attached to each document or the text content of each document” may be used.

The characteristic linguistic expression extraction unit 430 may set all characteristic linguistic expressions in the check target documents as relevant linguistic expression candidates. The characteristic linguistic expression extraction unit 430 may extract a characteristic linguistic expression using a text mining technique or a multiple document summarizing technique on the entire set of check target documents, and use the extracted linguistic expression as the relevant linguistic expression candidate.

In the present embodiment, the three functional units of the check target document condition selection unit 410, check target document set acquisition unit 420, and characteristic linguistic expression extraction unit 430 are combined, to function as the relevant linguistic expression candidate generation unit 40 which generates a relevant linguistic expression candidate.

The relevant linguistic expression candidate time-series data acquisition unit 50, in particular, is implemented by a CPU of an information processing apparatus which is driven in accordance with a program. The relevant linguistic expression candidate time-series data acquisition unit 50 includes a function of acquiring (extracting), from the document set database 30, time-series data on each relevant linguistic expression candidate generated by the relevant linguistic expression candidate generation unit 40. Since the only difference lies in the alteration from the target linguistic expression to the relevant linguistic, expression candidate, the processing method by which the relevant linguistic expression candidate time-series data acquisition unit 50 extracts time-series data is the same as the method by which the target linguistic expression time-series data acquisition unit 20 extracts time-series data.

It should be noted that the range of the time-series data to acquire (start time and end time) and the duration of the period are set to be the same as those of the target linguistic expression, time-series data so that the time-series analysis unit 60 can analyze temporal correlation of the time-series data with the target linguistic expression time-series data.

The time-series analysis unit 60, in particular, is implemented by a CPU of an information processing apparatus which is driven in accordance with a program. The time-series analysis unit 60 includes a function of analyzing the time-series data acquired by the target linguistic expression time-series data acquisition unit 20 and the time-series data of each relevant linguistic expression candidate acquired by the relevant linguistic expression candidate time-series data acquisition unit 50 for the presence or absence of temporal correlation therebetween. More specifically, when three relevant linguistic expression candidates of candidate 1, candidate 2, and candidate 3 are given, the time-series analysis unit 60 analyzes the three combinations of (target linguistic expression, candidate 1), (target linguistic expression, candidate 2), and (target linguistic expression, candidate 3) for the presence or absence of temporal correlation.

For the actual technique of time-series analysis to analyze the presence or absence of temporal correlation, the general statistical technique available to the public such as regression analysis may be used.

Even though the time-series data on the target linguistic expression and the time-series data on a certain relevant linguistic expression candidate are temporally correlated with each other, a change in either time-series data is not necessarily in synchronization with a change in the other time-series data. Thus, to check for the temporal correlation, correlation containing a certain period of time delay may be allowed between the time-series data.

For example, because an impact or effect of a new service comes afterward from its start, a time delay about one month before and after may thus be considered to check for the temporal correlation. Consequently, temporal correlation between time-series data can be determined even though the temporal correlation is generated between time-series data relating to the target linguistic expression of “new service” and time-series data relating to the relevant linguistic expression candidate of “service degraded” which delays three weeks from the target linguistic expression.

When two sequences of time-series data are given, the amount of calculation necessary to check for the temporal correlation therebetween increases as the time range of the time-series data to be checked is prolonged and as tolerance of time delay is prolonged. Thus, it is possible to firstly detect a major point of change occurring in each of time-series data, before checking the temporal correlation between the two sequences of time-series data. Then, it may be examined whether either one of the two sequences of time-series data contains a point of change corresponding to a point of change in the other sequence of time-series data, and the temporal correlation can be checked within an interval in the vicinity of the points of change only if the points are possible to correspond to each other. Alternatively, an given interval in the vicinity of the point of change in each of the time-series data may simply be subjected to the time-series analysis.

In addition, provided that a point at which the time-series data changes from 0 (or extremely small value) to a positive value is defined as the emerging point, and a point at which the time-series data changes from a positive value to 0 for extremely small value) is defined as the vanishing point, attention may be focused on the emerging point or the vanishing point in either one of the two sequences of time-series data. A given interval in the vicinity of the emerging point or the vanishing point may be set as a target region where the time-series analysis is preferentially performed.

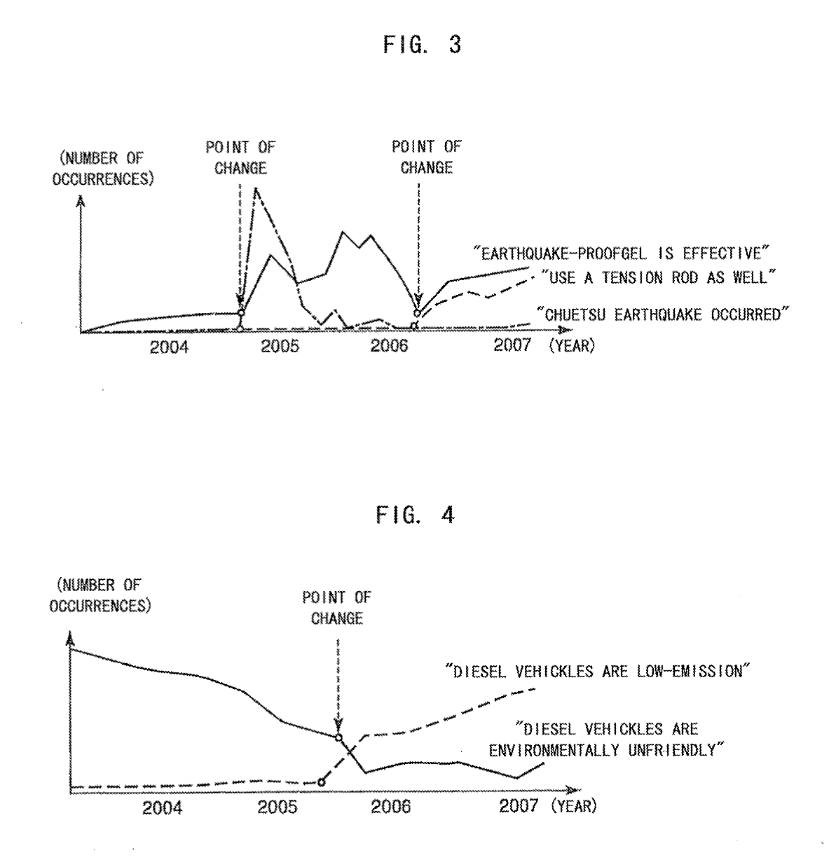

FIG. 3 is an explanatory diagram showing an example of time-series data on relevant, linguistic expression candidates that are positively correlated with a target linguistic expression. Here, the target linguistic, expression includes “Earthquake-proof gel is effective,” and the relevant linguistic expression candidates include “Chuetsu earthquake occurred” and “Use a tension rod as well.” In the example shown in FIG. 3, the numbers of occurrences of the respective linguistic expressions on the Internet are used as the time-series data. In the example shown in FIG. 3, the target linguistic expression “Earthquake-proof gel is effective” increased abruptly from the second half of 2004. Positively correlated with the increase of the target linguistic expression of “Earthquake-proof gel is effective,” the relevant linguistic expression candidate of “Chuetsu earthquake occurred” appeared and increased abruptly. Regarding the example of “Earthquake-proof gel is effective” and “Chuetsu earthquake occurred” shown in FIG. 3, the positive correlation is observed from about October 2004 through about February 2005. In the example shown in FIG. 3, the target linguistic expression of “Earthquake-proof gel is effective” and the relevant linguistic expression candidate of “Use a tension rod as well” also grow together in positive correlation from about March 2006 through about the early 2007.

FIG. 4 is an explanatory diagram showing an example of time-series data on a relevant linguistic expression candidate which is negatively correlated with a target linguistic expression. Here, the target linguistic, expression includes “Diesel vehicles are environmentally unfriendly” and the relevant linguistic expression candidate includes “Diesel vehicles are low-emission,” Also in the example shown in FIG. 4, the numbers of occurrences of the respective linguistic expressions on the Internet are used as the time-series data. In the example shown in FIG. 4, the target linguistic expression of “Diesel vehicles are environmentally unfriendly” decreases sharply from mid-year 2005 while the relevant linguistic expression candidate of “Diesel vehicles are low-emission” increases sharply from May 2005. The negative correlation is observed around November 2005. In the example shown in FIG. 4, the time-series data on the target linguistic expression includes a time delay of a month or so. As above, efficient detection can be made even in the example shown in FIG. 4 by preferentially performing the time-series analysis on certain periods in the vicinity of the points in time (points of change) where a major change is generated in the respective sequences of time-series data.

The relevance level calculation unit 70 is implemented, in particular, by a CPU of an information processing apparatus which is driven in accordance with a program. The relevance level calculation unit 70 includes a function of calculating the relevance level between a target linguistic expression and a relevant linguistic, expression candidate using the analysis result of the time-series analysis unit 60. Here, the relevance level calculation unit 70 may calculate the relevance level for each of the relevant, linguistic expression candidates generated by the relevant linguistic expression candidate generation unit 40. The relevance level calculation unit 70 may calculate the relevance level for only a relevant linguistic expression candidate or candidates of which the time-series analysis unit 60 has detected a certain value or higher of temporal correlation with the target linguistic expression.

Basically, the relevance level is set to indicate the magnitude of the temporal correlation detected by the time-series analysis unit 60. Specifically, a correlation coefficient that indicates a degree of correlation between the time-series data on the target linguistic expression and the time-series data on the relevant linguistic expression candidate may be used as the relevance level. The relevance level calculation unit 70 may determine the relevance level by averaging correlation coefficients over the time range where the correlation is observed, or may determine the relevance level by determining the maximum value in the time range. The relevance level calculation unit 70 may determine the relevance level by performing some normalization or representation processing based on the correlation coefficients.

When the relevant linguistic expression candidate generation unit 40 uses some measure to select a relevant linguistic expression candidate at the time of generating the relevant linguistic expression candidate, the relevance level calculation unit 70 may determine, as the relevance level, the linear sum of the value of the measure and the value indicating the degree of temporal correlation detected by the time-series analysis unit 60. Examples of the measure to select a relevant linguistic expression candidate include the number of link hops from a target document to the document containing the relevant linguistic expression candidate, and the text similarity between the set of target documents and the document containing the relevant linguistic expression candidate.

The relevance level calculation unit 70 also includes a function of passing (outputting) the relevance linguistic expression candidate and the calculation result of relevance level of the candidate to the relevant information output apparatus 80. Here, the relevance level calculation degree 70 may pass the analysis result of the time-series analysis unit 60 and the time range where the temporal correlation is detected to the relevant information output apparatus 80 in addition to the relevance level.

The relevant information output apparatus 80 is implemented, in particular, by a CPU of an information processing apparatus, which is driven in accordance with a program, and an output device such as a liquid crystal display. The relevant information output apparatus 80 includes a function of outputting linguistic expressions having a high relevance level to the target linguistic expression as relevant information on the target linguistic expression based on the calculations of the relevance level calculation unit 70. The relevant information output apparatus 80 may output only a relevant linguistic expression candidate, a relevance level of which is equal to or larger than a predetermined threshold, among relevant linguistic expression candidates of which the relevance level calculation unit 70 has calculated the relevance levels. The relevant information output apparatus 80 may output all the pairs of the relevant linguistic expression candidates and the degrees of relevance.

File relevant information output apparatus 80 may also output the time range where correlation between the target linguistic expression and a relevant linguistic expression candidate is detected in addition to the relevant linguistic expression candidate. The relevant information output apparatus 80 may further output the time-series data on the relevant linguistic expression candidate.

According to the above-described configuration, in the present embodiment, the information analysis apparatus can analyze relevance between a target linguistic expression to be analyzed and a linguistic expression which statistically less likely less likely to co-occur with the target linguistic expression in the same documents. The information output apparatus 80 may output only a linguistic expression which is not self-evident without outputting, a linguistic expression, of which relevance to the target linguistic expression can be determined to be self-evidently high without using the information analysis apparatus of the present embodiment, such as a linguistic expression quite likely to co-occur with target expression in the set of target documents.

The foregoing processing of screening relevant linguistic expression candidates to be output may be performed by any of the functional units of the relevant linguistic expression candidate generation unit 40, relevant linguistic expression candidate time-series data acquisition unit 50, time-series analysis unit 60, relevance level calculation unit 70, and relevant information output apparatus 80. Moreover, a text mining technique may be used to examine a degree of co-occurrence with the target linguistic expression in the set of target documents, and a linguistic expression co-occurring with the target linguistic expression giving a statistically-high certain correlation value or more may be screened out of the relevant linguistic expression candidates.

In the present embodiment, the information analysis apparatus includes the foregoing configuration and can output a linguistic expression, of which time-series data is temporally correlated, with that of an input target linguistic expression, as relevant information on the target linguistic expression, even though the linguistic expression does not co-occur with the target linguistic expression and not show up statistically-frequently in the same documents.

In the present embodiment, the information processing apparatus which realizes the information analysis apparatus includes a storage device containing various programs to analyze information on documents having time information and so on. For example, the storage device of the information processing apparatus which realizes the information analysis apparatus contains a program for information analysis that makes a computer to perform: relevant linguistic expression candidate generation processing for generating a candidate linguistic expression highly relevant to an input linguistic expression to be analyzed as a relevant linguistic expression candidate; and relevance level calculation processing for calculating a relevance level between the input linguistic expression and the generated relevant linguistic expression candidate.

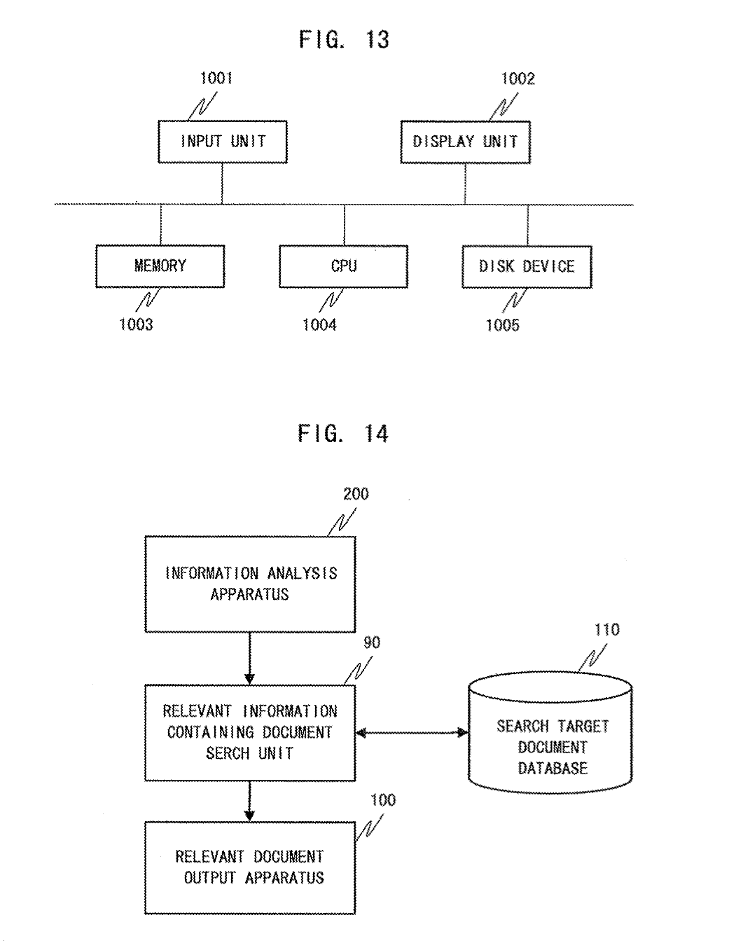

FIG. 13 is a block, diagram showing an example of a configuration of a computer for a fault cause analysis system according to the present embodiment.

Programs on which functions of a pan of the target linguistic expression input unit 10 and relevant information output apparatus 80, functions of the target linguistic expression time-series data acquisition unit 20, relevant linguistic expression candidate generation unit 40, relevant linguistic expression candidate time-series data acquisition unit 50, time-series analysis unit 60, and relevance level calculation unit 70 of the information analysis apparatus shown in FIG. 1 are described are stored in a disk device 1005 such as a hard disk drive. The disk device 1005 also contains the data of the document set database 30. The program is executed by a CPU 1004. Configured with an input unit 1001 is a pan of the target linguistic expression input unit 10, and the input unit 1001 provides an input device such as a keyboard. Configured with a display unit 1002 such as a liquid crystal display is a part of the relevant information output apparatus 80. The components of the information analysis apparatus are connected via a bus 1006 such as a data bus and information necessary for the information processing by the CPU 1004 is stored in a memory 1003 such as a DRAM to store.

In the present embodiment, the components shown in FIG. 1 are realized as a program (or programs) for controlling the respective functions, and the program is stored in a computer-readable information storage medium such as a flexible disk including an FD (floppy disk) a CD-ROM, a DVD, and a flash memory, or is provided through a network such as the Internet. The information analysis apparatus may be realized by the program being read and executed by an information processing apparatus such as a computer.

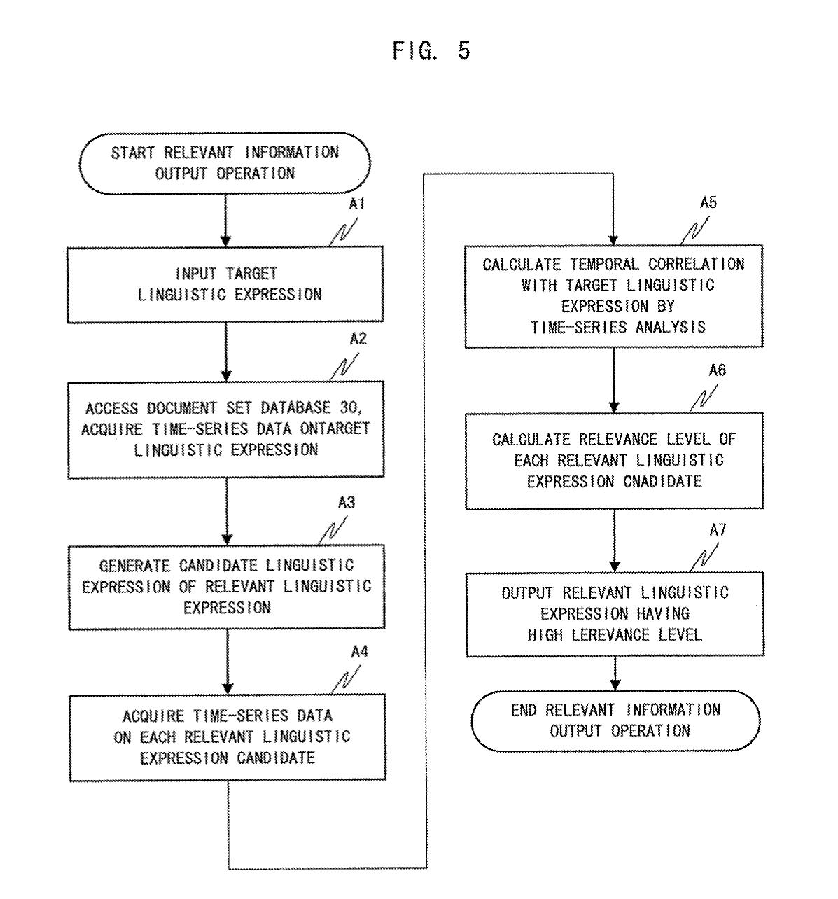

Next, the operations will be described. FIG. 5 is a flowchart showing the overall processing of a relevant information output operation for the information analysis apparatus to perform. As shown in FIG. 5, the target linguistic expression input unit 10 initially accepts an input of a linguistic expression to be analyzed in accordance with a user operation (step A1).

Next, the target linguistic expression time-series data acquisition unit 20 accesses the document set database 30 to acquire (extract) time-series data on the target linguistic expression from the document set database 30 (step A2). Since processing of step A2 and processing of steps A3 and A4 to be described later are highly independent from each other, an execution order of the processing of step A2 and processing of steps A3 and A4 may be changed as long as the steps come before step A5.

Next, the relevant linguistic expression candidate generation unit 40 generates, as a relevant linguistic expression candidate, a candidate linguistic expression which is highly relevant to the target linguistic expression input by the target linguistic expression input unit 10 (step A3). The relevant linguistic expression candidate time-series data acquisition unit 50 acquires (extracts), from the document set database 30, time-series data on each relevant linguistic expression candidate generated by the relevant linguistic expression candidate generation unit 40 in accordance with the same processing as in step A2 (step A4).

The time-series analysis unit 60 performs time-series analysis to determine temporal correlation between the time-series data on the target linguistic expression acquires at step A2 and the time-series data on each relevant linguistic expression candidate acquired at step A4 (step A5). Next, the relevance level calculation unit 70, using the analysis result of the time-series analysis determined at step A5, calculates a relevance level between the target linguistic expression and the relevant linguistic expression candidate (step A6).

Finally, based on the relevance level determined by the relevance level calculation unit 70, the relevant information output apparatus 80 outputs the relevant linguistic expression having a high relevance level, as relevant information on the target linguistic expression (step A7).

Through the foregoing processing, the processing of the overall operation of the information analysis apparatus is ended.

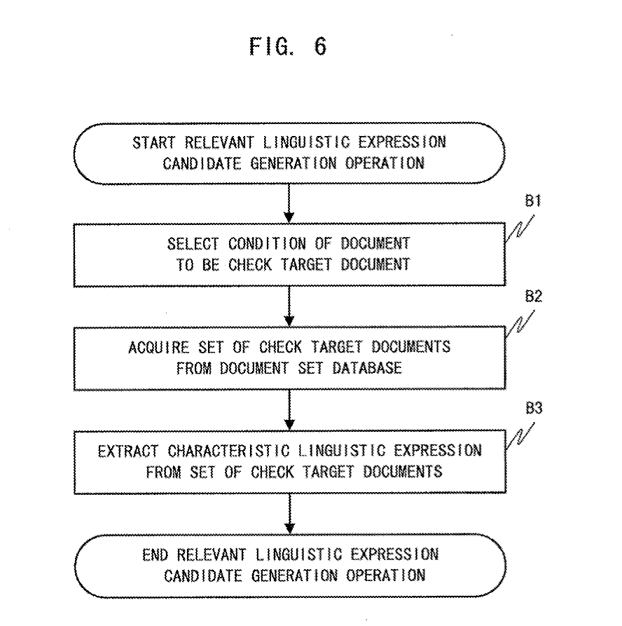

Next, the processing, of generating a relevant linguistic expression candidate shown in step A3 will be described in detail for the case where the relevant linguistic expression candidate generation unit 40 including the detailed configuration shown in FIG. 2, FIG. 6 is a flowchart showing an example of the relevant linguistic expression candidate generation processing; for the relevant linguistic expression candidate generation unit 40 to perform.

As shown in FIG. 6, to determine a relevant linguistic expression candidate, the check target document condition selection unit 410 firstly selects, as a conditions of check target document, a condition of a set of documents that is different from the set of check target documents containing the target linguistic expression; however includes a certain relationship with the target linguistic expression or the set of target documents (step B1).

Next, the check target document set acquisition unit 420 acquires (extracts) a set of check target documents which satisfy the condition selected at step B1 from the document set database 30 (step B2).

Finally, the characteristic linguistic expression extraction unit 430 extracts, as a relevant linguistic expression candidate, a linguistic expression which is characteristic of the set of check target documents acquired by the check target document set acquisition unit 420 (step B3), whereby the relevant linguistic expression candidate generation processing is ended.

As described above, according to the present embodiment, a candidate linguistic expression which is highly relevant to the input linguistic expression to be analyzed is generated as a relevant linguistic expression candidate. Then, a relevance level is calculated between the input linguistic expression and the generated relevant linguistic expression candidate. Therefore, a language may be regarded as a highly relevant expression and the relevance level thereof can be determined, even though the linguistic expression do not co-occur with the target linguistic expression to be analyzed in the same documents. Consequently, it is possible to analyze relevance between the target linguistic expression to be analyzed and a linguistic expression which is statistically less likely to co-occur with the target linguistic expression in the same documents.

According to the present embodiment, candidates of a linguistic expression having highly relevance are narrowed down based on contents of the target linguistic expression, text contents of a document containing the target linguistic expression, and meta information attached to the documents containing the target information expression. Time-series analysis is performed on the screened relevant linguistic expression candidates and, the target linguistic expression, whereby a linguistic expression highly relevant to the target linguistic expression can be output.

In particular, in the present embodiment, as the relevant linguistic expression candidate generation unit 40 includes the configuration detailed in FIG. 2, a check target document which is not exactly included in the set of target documents but includes a certain relationship from the target linguistic expression or the set of target documents is once selected, and a linguistic expression contained in the selected check target document can be determined to be a relevant linguistic expression candidate. Thus, the number of candidate linguistic expressions for the time-series analysis unit 60 to determine temporal relevance thereof can be appropriately narrowed down for efficient processing.

That is, in the case where a relevant linguistic expression is temporally-highly correlated with the target linguistic expression, even when the relevant linguistic expression is less likely to occur in the set of target documents, it is conceivable that the relevant linguistic expression shows up in a document having a certain relationship with the target linguistic expression or the set of target document. Thus, provided is a technique to narrow down candidates of the relevant linguistic expression having temporally-highly correlation in actual to a characteristic linguistic, expression occurring in the set of check target documents by appropriately selecting a check target document. Even a linguistic expression which does not show up in the set of target documents at all can be output as a relevant linguistic expression when the linguistic expression is contained in a check target document and is temporally correlated with the target linguistic expression, in the population to be analyzed.

### Embodiment 2

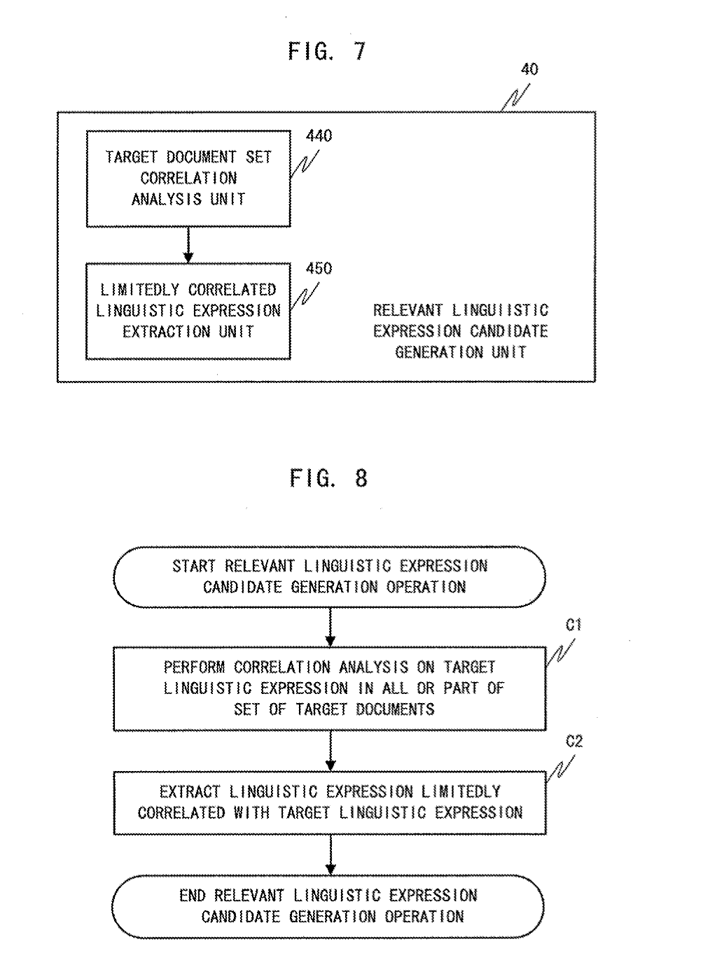

Next, an exemplary second embodiment of the present invention will be described with reference to the drawings. FIG. 7 is a block diagram showing an example of a configuration of the relevant linguistic expression candidate generation unit 40 according to the second embodiment. As shown in FIG. 7, the present embodiment differs from the first embodiment in that the relevant linguistic expression candidate generation unit 40 of the information analysis apparatus includes a target document set correlation analysis unit 440 and a limitedly correlated linguistic expression extraction unit 450. The relevant linguistic expression candidate generation unit 40 may include the target document set correlation analysis unit 440 and the limitedly correlated linguistic expression extraction unit 450 in addition to the components described in the first embodiment.

The only difference of the present embodiment from the first embodiment lies in the internal configuration of the relevant linguistic expression candidate generation unit 40. Since the overall configuration of the information analysis apparatus is the same as in the first embodiment (see FIG. 1), description of the overall configuration of the information analysis apparatus will be omitted. Hereinafter, description will be given only of the internal configuration of the relevant linguistic expression candidate generation unit 40 with reference to FIG. 7.

As shown in FIG. 7, the relevant linguistic expression candidate generation unit 40 includes the target document set correlation analysis unit 440 and the limitedly correlated linguistic expression extraction unit 450. The target document set correlation analysis unit 440 analyzes the set of target documents for the presence or absence of a linguistic expression occurring in limited correlation with the target linguistic expression. The limitedly correlated linguistic expression extraction unit 450 extracts a limitedly-correlated linguistic expression based on the analysis result of the set of target documents.

The target document set correlation analysis unit 440 includes function of analyzing car elation between a linguistic expression contained in the set of target documents and the target linguistic expression, using the text mining technique. In the present embodiment, the target document set correlation analysis unit 440 determines a linguistic expression which occurs in correlation with the input linguistic expression within part or all of the set of electronic documents containing the input linguistic expression. The target document set correlation analysis unit 440 may divide the set of target documents into several subsets, and analyze the correlation between a linguistic expression contained in each divided subset and the target linguistic expression in units of the subset instead of in units of the entire set of target documents.

An example of the text mining technique mentioned above is described in NPL 1.

When meta information is attached to each document, the target document set correlation analysis unit 440 may utilize a method to divide the set of target documents for each item of the meta information as a method to classify the set of target documents. The target document set correlation analysis unit 440 ma also use a method of separating documents by given time period based on time information attached to each document. The target document set correlation analysis unit 440 may further use an existing text clustering technique to divide the documents based on text contents of the documents.

The limitedly correlated linguistic expression extraction unit 450 includes a function of extracting a linguistic expression which is limitedly correlated with the target linguistic expression as a relevant linguistic expression candidate in correspondence with the analysis result of the target document set correlation analysis unit 440. In the present embodiment, the limitedly correlated linguistic expression extraction unit 450 extracts, as the relevant linguistic expression candidate, a linguistic expression which shows up providing a certain correlation value or higher with the input linguistic expression using the calculation result of the target document set correlation analysis unit 440.

Here, limitedly-correlation means to a linguistic expression, of which a value indicating the correlation level with the target linguistic expression lies between a given lower limit and a given upper limit, when the target document set correlation analysis unit 440 analyzes the entire set of target documents.

A linguistic expression which has a degree of correlation with the target linguistic expression larger than a given threshold can be determined using the text mining technique. To realize the information analysis apparatus so as not to cover linguistic expressions which can be determined by related technologies such as the text mining technique, such a threshold may be set as the upper limit. In contrast, when such linguistic expressions that can be determined by the text mining technology are to be covered as well, setting the upper limit may be omitted.

Setting the lower limit is required. When the lower limit is set too small, the number of linguistic expressions to be extracted as relevant linguistic expression candidates increases, and the calculation amount in the time-series analysis unit 60 also increases. Thus, the lower limit is set in advance in view of the application and purpose of implementation of the information analysis apparatus and the properties of the population to be analyzed and so on.

When the target document set correlation analysis unit 440 analyzes subsets of the set of target documents for correlation with the target linguistic expression, the limitedly correlated linguistic expression extraction unit 450 extracts, as a limitedly-correlated linguistic expression, a linguistic expression of which value indicating the correlation with the target linguistic expression in each subset reaches or exceeds a given value, and determines the linguistic expressions as the relevant linguistic expression candidate. Consequently, extracted is a linguistic expression showing a highly correlation with the target linguistic expression if analyzed in a limited set of documents in a certain period, category, or the like, and the linguistic expression shows no particular correlation with the target linguistic expression in the entire set of the target documents.

In the present embodiment, the information analysis apparatus includes the relevant linguistic expression candidate generation unit 40 including the described above internal configuration in addition to the overall configuration shown in FIG. 1.

In the present embodiment, the components shown in FIGS. 1 and 7 are realized d as a program (or programs) for controlling the respective functions and the program is stored in a computer-readable information storage medium such as a flexible disk including an FD (floppy disk), a CD-ROM, a DVD, and a flash memory, or is provided through a network such as the Internet. The in formation analysis apparatus may be realized by the program being read and executed by an information processing apparatus such as a computer.

Next, the operations will be described. The overall processing of the relevant information output operation for the information analysis apparatus to perform in the present embodiment is the same as that described in the first embodiment and the description thereof will be omitted. Since the only difference from the first embodiment lies in the part pertaining to the relevant linguistic expression candidate generation processing at step A3 shown in FIG. 5, description will hereinafter be given of the relevant linguistic expression candidate generation processing. FIG. 8 is a flowchart showing an example of the relevant linguistic expression candidate generation processing for the relevant linguistic expression candidate generation unit 40 to perform in the second embodiment.

As shown in FIG. 8, the target document set correlation analysis unit 440 firstly performs correlation analysis, in the entire set of target documents or some subsets thereof, for the target linguistic expression (step C1). Next, the limitedly correlated linguistic expression extraction unit 450 extracts a linguistic expression limitedly correlated with the target linguistic expression based on the result of the correlation analysis at step C1, and outputs the linguistic expression as a relevant linguistic expression candidate (step C2). The relevant linguistic expression candidate generation processing according to the present embodiment is thus ended.

As described above, according to the present embodiment, since the relevant linguistic expression candidate generation unit 40 includes the configuration detailed in FIG. 7, correlation between the target linguistic expression can be detected even for a linguistic expression, which is contained in the set of target documents but correlation thereof with the target linguistic expression can not be found using the text mining technology of the related art described in NPL 1. More specifically, in the present embodiment, a linguistic expression which is correlated with the target linguistic expression only in a limited way in the set of target documents is once extracted as a relevant linguistic expression candidate. Then, temporal correlation between the target linguistic expression and the relevant linguistic expression candidate is examined, in the entire population to be analyzed. Consequently, by examining whether the candidate is actually relevant to the target linguistic expression, it is possible to detect correlation between the target linguistic expression and a linguistic expression, for which highly correlation with the target linguistic expression is not possible to be found by using the text mining technique.

### Embodiment 3

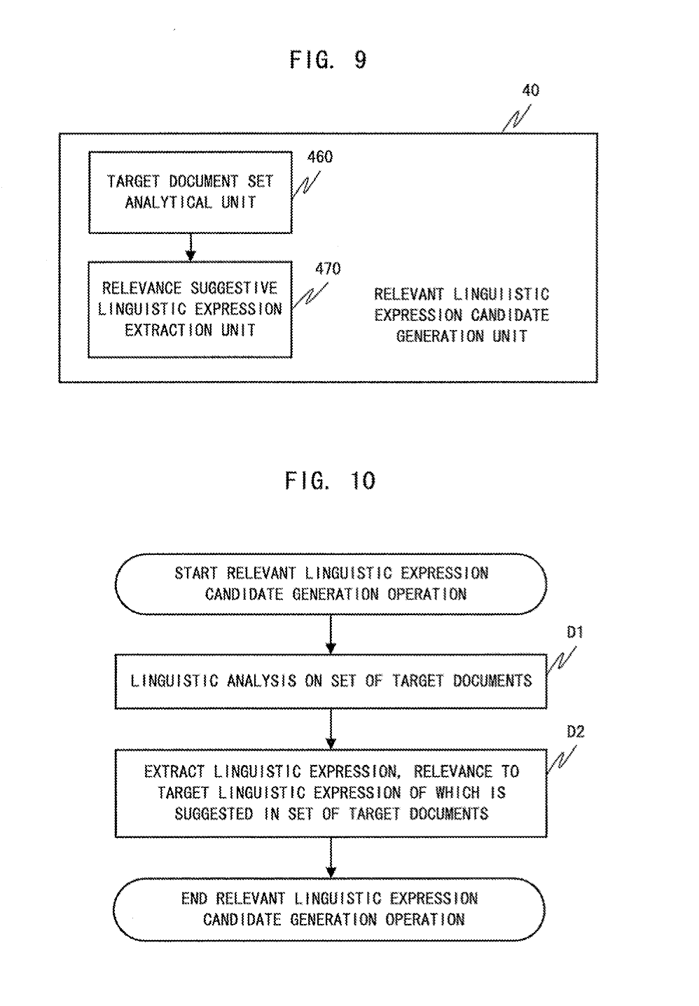

Next, an exemplary third embodiment of the present invention will be described with reference to the drawings. FIG. 9 is a block diagram showing an example of a configuration of the relevant linguistic expression candidate generation unit 40 according to the third embodiment. As shown in FIG. 9, the present embodiment differs from the first embodiment in that the relevant linguistic expression candidate generation unit 40 of the information analysis apparatus includes a target document set analytical unit 460 and a relevance suggestive linguistic expression extraction unit 470. The relevant linguistic expression candidate generation unit 40 may include the target document set analytical unit 460 and the relevance suggestive linguistic expression extraction unit 470 in addition to the components described in the first embodiment or second embodiment.

The only difference of the present embodiment from the first embodiment lies in the internal configuration of the relevant linguistic expression candidate generation unit 40. Since the overall configuration of the information analysis apparatus is the same as in the first embodiment (see FIG. 1), description, of the overall configuration of the information analysis apparatus will be omitted. Hereinafter, description will be given only of the internal configuration of the relevant linguistic expression candidate generation unit 40 with reference to FIG. 9.

As shown in FIG. 9, the relevant linguistic expression candidate generation unit 40 includes the target document set analytical unit 460 and the relevance suggestive linguistic expression extraction unit 470. The target document set analytical unit 460 performs linguistic analysis on the set of target documents. The relevance suggestive linguistic expression extraction unit 470 extracts a linguistic expression which includes a description which suggests relevance to the target linguistic expression based on the result of the linguistic analysis.

The target document set analytical unit 460 includes a function of determining a set of target documents and that performing linguistic analysis on each document included in the determined set of target documents. In the present embodiment, the target document set analytical unit 460 linguistically analyzes part or all of a set of electronic documents containing the input linguistic expression. Details of processing to be performed as the linguistic analysis is determined depending on the type and form of linguistic expressions to be dealt with when the information analysis apparatus is implemented. No additional linguistic analysis is needed if each document is linguistically analyzed in advance of processing of determining the set of target documents.

The relevance suggestive linguistic expression extraction unit 470 includes a function of examining a linguistic analysis result in the vicinity of the target linguistic expression for each document in the set of target documents, and searching for a description of another linguistic expression, regarding to which relevance to the target linguistic expression is suggested. In the present embodiment; the relevance suggestive, linguistic expression extraction unit 470 extracts as a relevant linguistic expression candidate, a linguistic expression for which relevance to the input linguistic expression is suggested using the analysis result of the target document set analytical unit 460. If there is a description of another linguistic expression for which relevance to the target linguistic expression is suggested, the relevance suggestive linguistic expression extraction unit 470 extracts all such relevance-suggested linguistic expressions, and outputs the linguistic expressions as relevant linguistic, expression candidates.

In order to determine the suggestiveness of the relevance to the target linguistic expression, a plurality of text patterns in which one linguistic expression suggests a cause, effect, or relationship of another are prepared, such as “linguistic expression> is related to <linguistic expression>,” “<linguistic expression> causes <linguistic expression>,” “<linguistic, expression> makes an impact on <linguistic expression>,” and “<linguistic expression> due to <linguistic expression>.” When the target linguistic expression matches with either one of the linguistic expressions in such text patterns, the relevance suggestive linguistic expression extraction unit 470 extracts the other linguistic expression as a relevant linguistic expression candidate.

Alternatively, the relevance suggestive linguistic expression extraction unit 470 may perform up to syntactic analysis and semantic analysis on each document in the set of target documents, and extract a linguistic expression for which relationship with the target linguistic expression is suggested from the analysis result.

In the present embodiment, the information analysis apparatus includes the relevant, linguistic expression candidate generation unit 40 including the above described the internal configuration in addition to the overall configuration shown in FIG. 1.

In the present embodiment, the components shown in FIGS. 1 and 9 are realized as a program for programs) controlling the respective functions and the program is stored in a computer-readable information storage medium such as a flexible disk including an PD (floppy disk), a CD-ROM, a DVD, and a flash memory, or is provided through a network such as the Internet. The information analysis apparatus may be realized by the program being read and executed by a computer or the like.

Next, the operations will be described. The overall processing of the relevant information output operation for the information analysis apparatus to perform in the present embodiment is the same as that described in the first embodiment and the description thereof will be omitted. Since the only difference from the first embodiment lies in the part pertaining to the relevant linguistic, expression candidate generation processing at step A3 shown in FIG. 5, description will hereinafter be given of the relevant linguistic expression candidate generation processing. FIG. 10 is a flowchart showing an example of the relevant linguistic expression candidate generation processing for the relevant linguistic expression candidate generation unit 40 to perform in the third embodiment.

As shown in FIG. 10, the target document set analytical unit 460 firstly performs linguistic analysis on the set of target documents (step D1). Next, the relevance suggestive linguistic expression extraction unit 470 searches each document in the set of target documents for a description of other linguistic expressions whose relevance to the target linguistic expression is suggested. The relevance suggestive linguistic expression extraction unit 470 extracts a linguistic expression which is found by the search, and outputs the linguistic expressions as a relevant linguistic expression candidate (step D2), whereby the relevant linguistic expression candidate generation processing according to the present embodiment is ended.

As described above, according, to the present embodiment, since the relevant linguistic expression candidate generation unit 40 includes the configuration detailed in FIG. 9, it is possible to detect relevance with a target linguistic expression if anyone of the creators of the target documents has realized relevance between the target linguistic expression and another linguistic expression, and described that in a target document. Since such descriptions by the creators of the target documents can contain a lot of errors, the relevant linguistic, expression candidate generation unit 40 once extracts a relevance-suggested linguistic expression as a relevant linguistic expression candidate. Then, temporal correlation in the entire population to be analyzed between the target linguistic expression and the relevant linguistic expression candidate is examined. Such examination of the actual relevance to the target linguistic expression makes it possible to detect relevant information with high precision.

### Embodiment 4

Next, an exemplary fourth embodiment of the present invention will be described with reference to the drawings. FIG. 11 is a block diagram showing an example of a configuration of the relevant linguistic expression candidate generation unit 40 according to the fourth embodiment. As shown in FIG. 11, the present embodiment differs from the first embodiment in that the relevant linguistic expression candidate generation unit 40 of the information analysis apparatus includes a target linguistic expression analytical unit 480 and a contradictory linguistic expression generation unit 490. The relevant linguistic expression candidate generation unit 40 may include the target linguistic expression analytical unit 480 and the contradictory linguistic expression generation unit 490 in addition to the components described in the first to third embodiments.

The only difference of the present embodiment from the first embodiment lies in the internal configuration of the relevant linguistic expression candidate generation unit 40. Since the overall configuration of the information analysis apparatus is the same as in the first embodiment (see FIG. 1), description of the overall configuration of the information analysis apparatus will be omitted. Hereinafter, description will be given only of the internal configuration of the relevant linguistic expression candidate generation unit 40 with reference to FIG. 11.

As shown in FIG. 11, the relevant linguistic expression candidate generation unit 40 includes the target linguistic expression analytical unit 480 and the contradictory linguistic expression generation unit 490. The target linguistic expression analytical unit 480 performs linguistic analysis on the target linguistic expression. The contradictory linguistic expression generation unit 490 generates a linguistic expression which is contradictory to the target linguistic expression based on the result of the linguistic analysis.

The target linguistic expression analytical unit 480 includes a function of performing linguistic analysis on the target linguistic expression. The specific content of the linguistic analysis depends on the processing of the contradictory linguistic expression generation unit 490 to be described later. For example, when the contradictory linguistic expression generation unit 490 to be described later generates a linguistic expression by negating die target linguistic expression, the target linguistic expression analytical unit 480 needs to perform morphological analysis and syntactic analysis.

The contradictory linguistic expression generation unit 490 includes a function of reading the result of the linguistic analysis performed on the target linguistic expression and generating a linguistic expression which is semantically contradictory to the target linguistic expression. In the present embodiment, the contradictory linguistic expression generation unit 490 generates, as the relevant linguistic expression candidate, a linguistic expression contradictory to the input linguistic expression using the analysis result of the target linguistic expression analytical unit 480.

As an example of the semantically contradictory linguistic expression, the contradictory linguistic expression generation unit 490 generates a sentence by modifying a sentence which has originally been affirmative into a negative form. Moreover, the contradictory linguistic expression generation unit 490 generates a sentence by modifying a sentence which has originally been negative into an affirmative form, for example. In another example, the contradictory linguistic expression generation unit 490 generates a semantically contradictory linguistic expression using a technique of attaching a negative adjective, adverb, prefix, and the like.

For example, from the target linguistic expression of “Earthquake-proof gel is effective,” the contradictory linguistic expression generation unit 490 can generate such linguistic expressions as “Earthquake-proof gel is not effective” and “Earthquake-proof gel is ineffective” as contradictory linguistic, expressions. Such modifications into contradictory linguistic, expressions can be made by using pattern matching and syntactic analysis technologies.

When language resources such as antonym dictionaries, adversative expression dictionaries, and synonym dictionaries are available, the contradictory linguistic expression generation unit 490 can generate a contradictory linguistic expression using the various dictionary resources. Suppose, for example, that a synonym dictionary contains the knowledge that “environmentally friendly” and “low-emission” are synonymous expressions. In such a case, the contradictory linguistic expression generation unit 490, using the synonym dictionary, once generates the form of “Diesel vehicles are environmentally friendly,” which is negative form to the target linguistic expression of “Diesel vehicles are environmentally unfriendly”. The contradictory linguistic expression generation unit 490 can further generate “Diesel vehicles are low-emission.”

What kind of linguistic expression to be actually generated as the contradictory linguistic expression is determined in advance according to the application and purpose of implementation of the information analysis apparatus, the properties of the population to be analyzed, and the types of language resources available and so on.

In the present embodiment, the information analysis apparatus includes the relevant linguistic expression candidate generation unit 40 including the above described internal configuration in addition to the overall configuration shown in FIG. 1.

In the present embodiment, the components shown in FIGS. 1 and 11 are realized as a program (or programs) controlling the respective functions and the program is stored in a computer-readable information storage medium such as a flexible disk including an ED (floppy disk), a CD-ROM, a DVD, and a flash memory, or is provided through a network such as the Internet. The information analysis apparatus may be realized by the program being read and executed by a computer or the like.

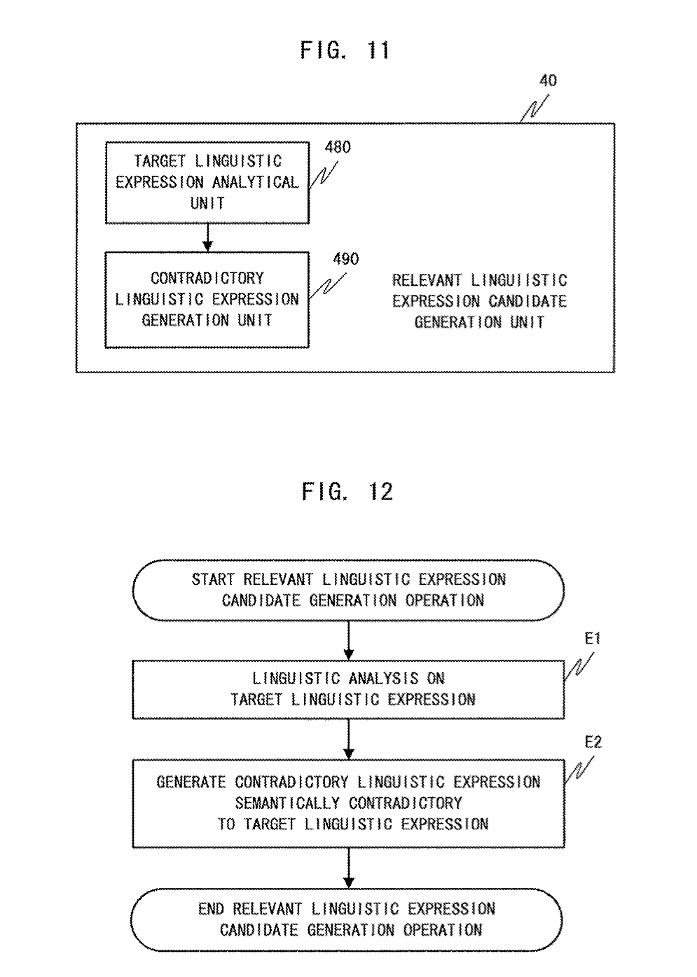

Next, the operations will be described. The overall processing of the relevant information output operation for the information analysis apparatus to perform in the present embodiment is the same as that shown in the first embodiment and the description thereof will be omitted. Since the only difference from the first embodiment lies in the part pertaining to the relevant linguistic expression candidate generation processing at step A3 shown in FIG. 5, description will hereinafter be given of the relevant linguistic expression candidate generation processing. FIG. 12 is a flowchart showing an example of the relevant linguistic expression candidate generation processing for the relevant linguistic expression candidate generation unit 40 to perform in the fourth embodiment.

As shown in HG. 12, the target linguistic expression analytical unit 480 performs linguistic analysis on the target linguistic expression (step E1). Next, the contradictory linguistic expression generation unit 490 generates a contradictory linguistic expression which is semantically contradictory to the target linguistic expression based on the result of the linguistic analysis on the target linguistic expression, and outputs the contradictory linguistic expression as a relevant linguistic expression candidate (step E2). The relevant linguistic expression candidate generation processing according to the present embodiment is thus ended.

As described above, according to the present embodiment, since the relevant linguistic expression candidate generation unit 40 includes the configuration detailed FIG. 11, a contradictory linguistic expression which is semantically contradictory to the target linguistic expression is directly generated by using linguistic processing technologies. Accordingly, the relevance with the target linguistic expression can be detected regardless of whether or not a contradictory linguistic expression is contained in the set of target documents or the set of check target documents. More specifically, a contradictory linguistic expression is once extracted as a relevant linguistic expression candidate, since all the contradictory linguistic expressions are not always actually correlated with the target linguistic expression. Then, temporal correlation in the entire population to be analyzed between the target linguistic expression and the relevant linguistic expression candidate is examined. Therefore, whether the relevant linguistic expression candidate is actually correlated with the target linguistic expression can be checked, and highly precise detection of relevant information is possible.

The information analysis apparatus according to each of the foregoing embodiments can be implemented by a program-driven information processing apparatus such as a computer. That is, the information analysis apparatus according to the present invention can be implemented by software. However, the components of the information analysis apparatuses shown in FIGS. 1, 2, 7, 9, and 11, or part of the components, may be configured as a dedicated IC for hardware implementation. When the information analysis apparatus includes a server to be connected with a terminal over a network, the target linguistic expression input unit 10 and the relevant information output apparatus 80 may be a communication unit for communicating with the terminal, without a keyboard, mouse, or liquid crystal display.

The information analysis apparatus according to each of the foregoing embodiments may be applied to a search system which presents, as a relevant information or relevant search condition, a linguistic expression which is highly relevant to a linguistic expression input from the information analysis apparatus.

FIG. 14 is a block diagram showing a configuration of a search system according to the present invention. The search system shown in FIG. 14 includes an information analysis apparatus 200, a relevant information containing document search unit 90, a relevant document output apparatus 100, and a search target document database 110. The information analysis apparatus 200 includes the information analysis apparatus of the first embodiment shown in FIG. 1; however, may be replaced by any one of the information analysis apparatuses of the second to fourth embodiments.

The relevant information containing document search unit 90 receives, as a search condition, a relevant linguistic expression output from the relevant information output apparatus 80 as relevant information, and searches a plurality of documents accessible in the search target document database 110 for a document containing the received relevant linguistic, expression. The relevant document output apparatus 100 outputs the document searched by the relevant information containing document search unit 90 as a relevant document. The search target document database 110 allows access to a set of documents to be searched. The search target document database 110 may include the same configuration as that of the document set database 30, or may be a database that provides access to a set of documents such as Internet text. The set of documents to be searched may be stored in the search target document database 110, or alternatively, merely access means to the documents such as URLs may be provided and main bodies of the documents may be stored outside. The relevant information output apparatus 800 may include merely the function of outputting a linguistic expression including a high relevance level to the target linguistic expression as relevant information of the target linguistic expression based on the calculation of the relevance level calculation unit 70, and need not include an output device such as a liquid crystal display.

Up to this point, representative embodiments of the present invention have been described. However, the present invention may be carried out in various other forms without departing from its spirit or essential characteristics set forth by the appended claims. The foregoing embodiments are therefore to be considered as mere illustrative and not restrictive. The scope of the invention is given by the appended claims, and is not restricted by the foregoing description or abstract. All changes and modifications which come within the meaning and range of equivalency of the claims are intended to be embraced within the scope of the present invention.

This application is based upon and claims the benefit of priority from prior Japanese Patent Application No, 2008-019014, filed 30 Jan. 2006. The contents of Japanese Patent Application No. 2008-019014 will be incorporated in the contents of description of this application.

### INDUSTRIAL APPLICABILITY

The present invention is applicable to the applications of analyzing text on the Internet such as blogs, and document data to which time information is attached such as correspondence history in a call center. The present invention is also applicable to such applications as the analysis of the results of questionnaire surveys and marketing researches that are conducted periodically. The present invention may also be applied to such applications as the detection of linguistic expressions highly relevant to target linguistic expressions for navigation purposes in document search and for classification of search results.

### REFERENCE SIGNS LIST

10: target linguistic expression input unit
20: target linguistic expression time-series data acquisition unit
30: document set database
40: relevant linguistic expression candidate generation unit
50: relevant linguistic expression candidate time-series data acquisition unit
60: time-series analysis unit
70: relevance level calculation unit
80: relevant information output apparatus
410: check target document condition selection unit
420: check target document set acquisition unit
430: characteristic linguistic expression extraction unit
440: target document set correlation analysis unit
450: limitedly correlated linguistic expression extraction unit
460: target document set analytical unit
470: relevance suggestive linguistic expression extraction unit
480: target linguistic expression analytical unit
490: contradictory linguistic expression generation unit

1. An information analysis apparatus comprising:
a target linguistic expression time-series data acquisition unit configured to acquire time-series data corresponding to an input linguistic expression to be analyzed;
a relevant linguistic expression candidate generation unit configured to generate a relevant linguistic expression candidate which is highly relevant to the input linguistic expression;
a relevant linguistic expression candidate time-series data acquisition unit configured to acquire time-series data corresponding to the relevant linguistic expression candidate generated by the relevant linguistic expression candidate generation unit;
a time-series analysis unit configured to analyze temporal correlation between the time-series data acquired by the target linguistic expression time-series data acquisition unit and the time-series data acquired by the relevant linguistic expression candidate time-series data acquisition unit; and
a relevance level calculation unit configured to calculate a relevance level between the input linguistic expression and the relevant linguistic expression candidate generated by the relevant linguistic expression candidate generation unit using an analysis result of the time-series analysis unit.

2. The information analysis apparatus according to claim 1, wherein the relevant linguistic expression candidate generation unit comprises:
a check target document condition selection unit configured to select a condition for extracting a document to be checked for the relevant linguistic expression candidate using text content of an electronic document containing the linguistic expression or meta information attached to a document containing the linguistic expression;
a check target document set acquisition unit configured to acquire a set of electronic documents which satisfy the condition for extracting; and
a characteristic linguistic expression extraction unit configured to extract, as the relevant linguistic expression candidate, a characteristic linguistic expression from the set of electronic documents acquired by the check target document set acquisition unit.

3. The information analysis apparatus according to claim 2, wherein the check target document condition selection unit selects, as the condition for extracting a document to be checked for the relevant linguistic expression candidate, whether the document includes an electronic document in a same or similar field or an electronic document relates to a same or similar topic as part or all of a set of electronic documents containing the (input) linguistic expression.

4. The information analysis apparatus according to claim 2, wherein the check target document condition selection unit selects, as the condition for extracting a document to be checked for the relevant linguistic expression candidate, whether the document includes an electronic document to which the electronic document containing the (input) linguistic expression is linked within a given number of hops.

5. The information analysis apparatus according to claim 2, wherein the check target document condition selection unit selects, as the condition for extracting a document to be checked for the relevant linguistic expression candidate, whether the document includes an electronic document which includes a given value of a text similarity or lower to the electronic document containing the linguistic expression.

6. The information analysis apparatus according to claim 2, wherein the check target document condition selection unit selects, as the condition for extracting a document to be checked for the relevant linguistic expression candidate, whether the document includes an electronic document which in common in a creator or issuer to part or all of the set of electronic documents containing the linguistic expression.

7. The information analysis apparatus according to claim 1, wherein the relevant linguistic expression candidate generation unit comprises:
a target document set correlation analysis unit configured to determine a linguistic expression which shows up in correlation with the linguistic expression in part or all of the set of electronic documents containing the linguistic expression; and
a limitedly correlated linguistic expression extraction unit configured to extract, as the relevant linguistic expression candidate, using a calculation result of the target document set correlation analysis unit, a linguistic expression showing up in correlation with the linguistic expression with a given value or higher.

8. The information analysis apparatus according to claim 1, wherein the relevant linguistic expression candidate generation unit comprises:
a target document set analytical unit configured to linguistically analyze part or all of the set of electronic documents containing the linguistic expression; and
a relevance suggestive linguistic expression extraction unit configured to extract, as the relevant linguistic expression candidate, a linguistic expression for which relevance to the linguistic expression is suggested by use of an analysis result of the target document set analytical unit.

9. The information analysis apparatus according to claim 1, wherein the relevant linguistic expression candidate generation unit includes:
a target linguistic expression analytical unit configured to linguistically analyze the linguistic expression; and
a contradictory linguistic expression generation unit configured to generate, as the relevant linguistic expression candidate, a linguistic expression which is contradictory to the linguistic expression using an analysis result of the target linguistic expression analytical unit.

10. A search system comprising:
the information analysis apparatus according to claim 1;
a relevant information containing document search unit configured to search, making the relevant linguistic expression output from the information analysis apparatus as a search condition, a plurality of search target documents for a document containing the relevant linguistic expression and having a high relevance level to a target linguistic expression; and
a relevant document output unit configured to output the document searched by the relevant information containing document search unit.

11. An information analysis method comprising:
acquiring time-series data corresponding to an input linguistic expression to be analyzed;
generating relevant linguistic expression candidate which is highly relevant to the input linguistic expression;
acquiring time-series data corresponding to the relevant linguistic expression candidate generated;
analyzing temporal correlation between the time-series data corresponding to the input linguistic expression and the time-series data corresponding to the relevant linguistic expression candidate; and
calculating a relevance level between the linguistic expression and the relevant linguistic expression candidate generated, using a result of analyzing the temporal correlation between the time-series data.

12. The information analysis method according to claim 11, wherein generating relevant linguistic expression candidate includes:
selecting a condition for extracting a document to be checked for the relevant linguistic expression candidate using text content of an electronic document containing the linguistic expression or meta information attached to a document containing the linguistic expression;
acquiring a set of electronic documents which satisfy the condition for extracting; and
extracting, as the relevant linguistic expression candidate, a characteristic linguistic expression from the set of electronic documents acquired.

13. The information analysis method according to claim 12, wherein selecting the condition for extracting includes
selecting, as a condition for extracting a document to be checked for the relevant linguistic expression candidate, whether the document includes an electronic document in a same or similar field or an electronic document relates to a same or similar topic as part or all of a set of electronic documents containing the linguistic expression.

14. The information analysis method according to claim 12, wherein selecting the condition for extracting includes
selecting, as the condition for extracting a document to be checked for the relevant linguistic expression candidate, whether the document includes an electronic document to which the electronic document containing the linguistic expression is linked within a given number of hops.

15. The information analysis method according to claim 12, wherein selecting the condition for extracting includes
selecting, as the condition for extracting a document to be checked for the relevant linguistic expression candidate, whether the document includes an electronic document which includes a given value of a text similarity or lower to the electronic document containing the linguistic expression.

16. The information analysis method according to claim 12, wherein selecting the condition for extracting includes
selecting, as the condition for extracting a document to be checked for the relevant linguistic expression candidate, whether the document includes an electronic document which in common in a creator or issuer to part or all of the set of electronic documents containing the linguistic expression.

17. The information analysis method according to claim 11, wherein generating a relevant linguistic expression candidate includes:
determining a linguistic expression which shows up in correlation with the linguistic expression in part or all of the set of electronic documents containing the linguistic expression; and
extracting, as the relevant linguistic expression candidate, a linguistic expression showing up in correlation with the linguistic expression with a given value or higher.

18. The information analysis method according to claim 11, wherein generating a relevant linguistic expression candidate includes:
linguistically analyzing part or all of the set of electronic documents containing the linguistic expression; and
extracting, as the relevant linguistic expression candidate, a linguistic expression for which relevance to the linguistic expression is suggested by use of a result of linguistically analyzing.

19. The information analysis method according to claim 12, wherein generating a relevant linguistic expression candidate includes:
linguistically analyzing the linguistic expression; and
generating, as the relevant linguistic expression candidate, a linguistic expression which is contradictory to the linguistic expression using a result linguistically analyzing.

20. A program for information analysis for causing a computer to perform:
acquiring time-series data corresponding to an input linguistic expression to be analyzed;
generating relevant linguistic expression candidate which is highly relevant to the input linguistic expression;
acquiring time-series data corresponding to the relevant linguistic expression candidate generated;
analyzing temporal correlation between the time-series data corresponding to the input linguistic expression and the time-series data corresponding to the relevant linguistic expression candidate; and
calculating a relevance level between the linguistic expression and the relevant linguistic expression candidate generated, using a result of analyzing the temporal correlation between the time-series data.

21. The program for information analysis according to claim 20, wherein
causing the computer to perform generating relevant linguistic expression candidate includes causing the computer to perform:
selecting a condition for extracting a document to be checked for the relevant linguistic expression candidate using text content of an electronic document containing the linguistic expression or meta information attached to a document containing the linguistic expression;
acquiring a set of electronic documents which satisfy the condition for extracting; and
extracting, as the relevant linguistic expression candidate, a characteristic linguistic expression from the set of electronic documents acquired.

22. The program for information analysis according to claim 21, wherein
causing the computer to perform selecting the condition for extracting includes causing the computer to perform
selecting, as a condition for extracting a document to be checked for the relevant linguistic expression candidate, whether the document includes an electronic document in a same or similar field or an electronic document relates to a same or similar topic as part or all of a set of electronic documents containing the linguistic expression.

23. The program for information analysis according to claim 21,
causing the computer to perform selecting the condition for extracting includes causing the computer to perform
selecting, as the condition for extracting a document to be checked for the relevant linguistic expression candidate, whether the document includes an electronic document to which the electronic document containing the linguistic expression is linked within a given number of hops.

24. The program for information analysis according to claim 21,
causing the computer to perform selecting the condition for extracting includes causing the computer to perform
selecting, as the condition for extracting a document to be checked for the relevant linguistic expression candidate, whether the document includes an electronic document which includes a given value of a text similarity or lower to the electronic document containing the linguistic expression.

25. The program for information analysis according to claim 21,
causing the computer to perform selecting the condition for extracting includes causing the computer to perform
selecting, as the condition for extracting a document to be checked for the relevant linguistic expression candidate, whether the document includes an electronic document which in common in a creator or issuer to part or all of the set of electronic documents containing the linguistic expression.

26. The program for information analysis according to claim 20,
causing the computer to perform generating a relevant linguistic expression candidate includes causing the computer to perform:
determining a linguistic expression which shows up in correlation with the linguistic expression in part or all of the set of electronic documents containing the linguistic expression; and
extracting, as the relevant linguistic expression candidate, a linguistic expression showing up in correlation with the linguistic expression with a given value or higher.

27. The program for information analysis according to claim 20,
causing the computer to perform generating a relevant linguistic expression candidate includes:
linguistically analyzing part or all of the set of electronic documents containing the linguistic expression; and
extracting, as the relevant linguistic expression candidate, a linguistic expression for which relevance to the linguistic expression is suggested by use of a result of linguistically analyzing.

28. The program for information analysis according to claim 20,
causing the computer to perform generating a relevant linguistic expression candidate includes causing the computer to perform:
linguistically analyzing the linguistic expression; and
generating, as the relevant linguistic expression candidate, a linguistic expression which is contradictory to the linguistic expression using a result linguistically analyzing.
